(19) United States
(12) Patent Application Publication
(10) Pub. No.: US 2018/0253448 A1
(43) Pub. Date: Sep. 6, 2018

(54) Systems, Devices, and Methods for Determining Relocation Destinations for Distributed Objects

(71) Applicant: Wal-Mart Stores, Inc., Bentonville, AR (US)

(72) Inventor: Sai Phaneendra Sri Harsha Viswanath Putcha, Harsha, Bentonville, AR (US)

(21) Appl. No.: 15/878,992

(22) Filed: Jan. 24, 2018

Related U.S. Application Data
(60) Provisional application No. 62/465,554, filed on Mar. 1, 2017.

(51) Int. Cl. G06F 17/30; G06K 7/14; G06K 15/02; B65G 1/137

(52) U.S. Cl. CPC G06F 17/30283; G06K 7/1413; G06K 7/1417; B65G 2201/02; B65G 1/1371; G06K 2215/0097; G06K 15/024

(57) ABSTRACT

Methodologies, systems, and computer-readable media are provided for determining relocation destinations for distributed objects. An electronic device scans a machine-readable code associated with an object and transmits information related to the object to a computing system. The computing system determines a destination location for the object and computes a set of data representative of the current value of the object. The computing system receives the set of data and autonomously controls a printer to print a visual representation of the set of data on a label.

### CROSS-REFERENCED APPLICATIONS

This application claims priority to U.S. Provisional Patent Application Ser. No. 62/465,554, entitled “SYSTEMS, DEVICES, AND METHODS FOR DETERMINING RELOCATION DESTINATIONS FOR DISTRIBUTED OBJECTS,” filed on Mar. 1, 2017, which is hereby incorporated by reference in its entirety.

### BACKGROUND

Various types of objects can be relocated using delivery vehicles. Relocating such objects can involve scheduling vehicles to retrieve the objects.

### SUMMARY

In one example embodiment, a system for determining relocation destinations for distributed objects includes a mobile electronic device configured to scan a machine-readable code associated with an object to be relocated from a first location. The system also includes one or more databases configured to store information related to the object. The information includes an attribute of the object and an amount of time the object has been at the first location. The system also includes a computing system including a first server in communication with the mobile electronic device and the one or more databases, and a second server in communication with the first server, the one or more databases, and a printer. The first server is configured to execute a relocation module to determine a destination location from a plurality of possible locations for the object. The first server is at a different location than the destination location. The first server is also configured to execute a module to compute a set of data representative of an attribute value to be assigned to the object at the destination location. The set of data is computed, at least in part, based on a stored attribute of the object, the amount of time the object has been at the first location, a current quality of the object, or the destination location. The second server and the printer are located at the destination location, and the second server is configured to receive the set of data and autonomously control the printer to print a visual representation of the set of data on a label to be affixed to the object.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings are primarily for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present invention will be more fully understood from the following description of exemplary embodiments when read together with the accompanying drawings, in which:

FIG. 1 is a flowchart illustrating an exemplary method for determining relocation destinations for distributed objects, according to an exemplary embodiment.

FIG. 2A is a flowchart illustrating another exemplary method for determining relocation destinations for distributed objects, according to an exemplary embodiment.

FIG. 2B is a flowchart illustrating another exemplary method for determining relocation destinations for distributed objects, according to an exemplary embodiment.

FIG. 3 is a diagram of an exemplary network environment suitable for a distributed implementation of an exemplary embodiment.

FIG. 4 is a block diagram of an exemplary computing device that can be used to perform exemplary processes in accordance with an exemplary embodiment.

### DETAILED DESCRIPTION

Following below are more detailed descriptions of various concepts related to, and embodiments of, inventive methods, apparatus, and systems for determining relocation destinations for distributed objects. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

Methodologies, systems, apparatus, and non-transitory computer-readable media are described herein to facilitate determining relocation destinations for distributed objects. In exemplary embodiments, a system for determining relocation destinations includes a mobile electronic device and a computing system to determine a relocation destination for an object and compute a set of data representative of the current value of the object. For example, a relocation destination can be a distribution center or the source location from which the object originated. Once a destination location is determined, the set of data representative of the current value of the object can be computed based on the life of the object, how long the object has been away from the source location, the quality of the object, the location of the destination location, or other object attributes. For example, if a perishable object has been away from the source location for two days, the set of data will indicate a lower current value for the object than if it had been away from the source location for only two hours. In exemplary embodiments, a mobile electronic device associated with a vehicle used for retrieving the object can scan a machine-readable code associated with the object in order to determine object attributes.

In exemplary embodiments, the individual wishing to return the object can request retrieval of the object using a mobile application or an online account. Once the retrieval request has been received by a computing system, the system can determine a vehicle responsible for retrieving the object. In exemplary embodiments, the vehicle can be determined based on one or more object attributes, such as whether the object requires a refrigerated truck or a truck of a particular size. The system can also transmit a notification to the vehicle, notifying the vehicle's operator that they are responsible for retrieving the object. In exemplary embodiments, the system can compute an updated vehicle route and transmit this route to the vehicle in order to guide the vehicle to retrieve the object. The systems, devices, and methods described herein can help ensure that the vehicle assigned to retrieve an object is the proper type of vehicle and can dynamically reroute the vehicle in order to facilitate retrieval and relocation of the object.

In exemplary embodiments, once the vehicle responsible for retrieving the object arrives at the objects location, a mobile electronic device associated with the vehicle can scan a machine-readable code associated with the object, such as a barcode, to determine various object attributes. For example, the mobile electronic device can confirm or determine the identity of the object, the time when the object was originally delivered to its current location, the source location of the object, the identity of the individual requesting retrieval of the object, etc.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

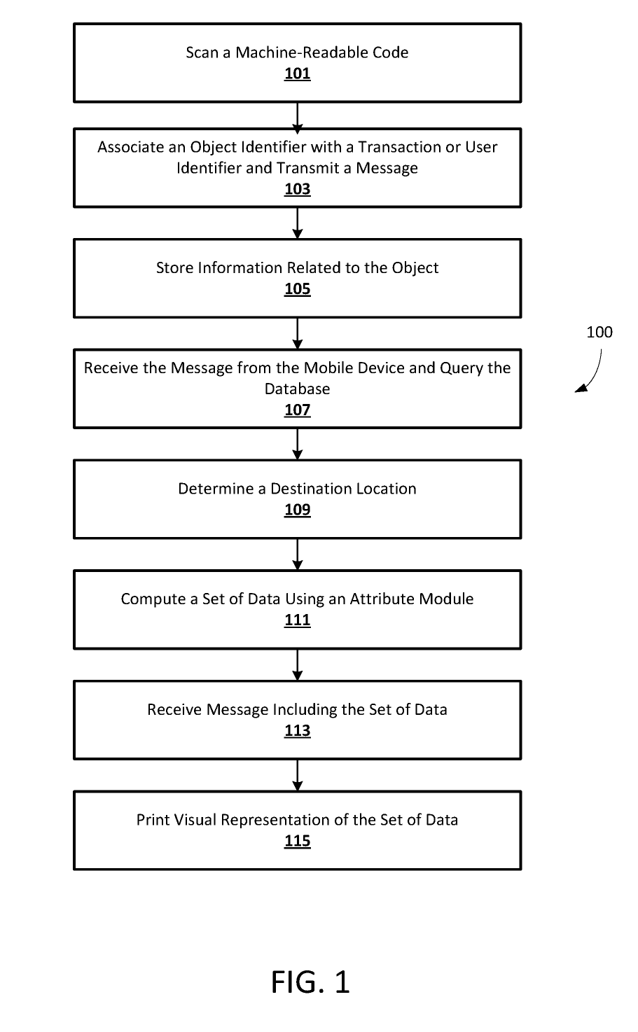

FIG. 1 is a flowchart illustrating an exemplary method 100 for determining relocation destinations for distributed objects and dynamically specifying one or more parameters for the objects at the relocation destinations, according to an exemplary embodiment. It will be appreciated that the method is programmatically performed, at least in part, by one or more computer-executable processes executing on, or in communication with one or more servers described further below. An object can reside a first location, but require relocation to a destination location. In step 101, a mobile electronic device at the first location can scan a machine-readable code associated with an object to be relocated. The mobile electronic device can include a smartphone, tablet, GPS enabled device, or any other electronic device suitable for scanning machine-readable codes. The machine-readable code can include, for example, a barcode, a three dimensional barcode, an RFID tag, etc. In step 103, upon scanning the object an application executing on the mobile electronic device can associate an object identifier encoded in the machine-readable code with a transaction identifier or a user identifier and can generate and transmit a message including the object identifier and the transaction identifier or the user identifier.

In step 105, information related to the object is stored at one or more databases. In exemplary embodiments, the information related to the object can include an attribute of the object and an amount of time the object has been at the first location. Attributes of the object can include physical attributes and/or logical attributes. Some example of attributes that can be associated with the object can include an expected expiration of the object, whether the object is perishable, a volume of the object, an original or source location at which the object resided before residing at the first location, other objects from the source location that now reside with the object at the first location, a time the object arrived at the first location, a time the object arrived at the source location. In step 107, a first server can receive the message from the mobile electronic device and can query the database using the object identifier and the transaction identifier or the user identifier to retrieve the information related to the object from the one or more databases.

In step 109, the first server dynamically and autonomously determines a destination location from possible destination locations for the object using a relocation module, the information related to the object retrieved from the database, contemporaneous information about the possible destination locations, and/or historical information about the destination locations. The first server is at a different location than the destination location, and the destination location can be, for example, a distribution center. In exemplary embodiments, the object arrived at the first location from the source location, and the destination location can be the source location from which the object originated or can be a different location.

In step 111, the first server computes a set of data representative of a current data value to be assigned to the object using an attribute module. In exemplary embodiments, the set of data is computed, at least in part, based on the attribute(s) of the object, the amount of time the object has been at the first location, and/or the destination location. For example, if the object is the object has an associated expiration and has been at the first location for a period of time, the set of data may indicate that a lower data value should be assigned to the object than if the object had been at the first location for less than the period of time. In another example embodiment, if the destination location is an urban location, the set of data may indicate a higher data value should be assigned to the object than if the destination location were a rural location.

In step 113, a second server receives a message including the set of data computed in step 111 from the first sever. In exemplary embodiments, the second server is in communication with the first server, the databases, and a printer, and is the second server and the printer can be disposed at the destination location.

In step 115, the second server autonomously controls the printer at the destination location to print a visual representation of the set of data on a label to be affixed to the object when it arrives at the destination location in response to receipt of the message from the first server. In exemplary embodiments, the visual representation can include a barcode, a three dimensional barcode, text, numbers, or any other suitable visual representation.

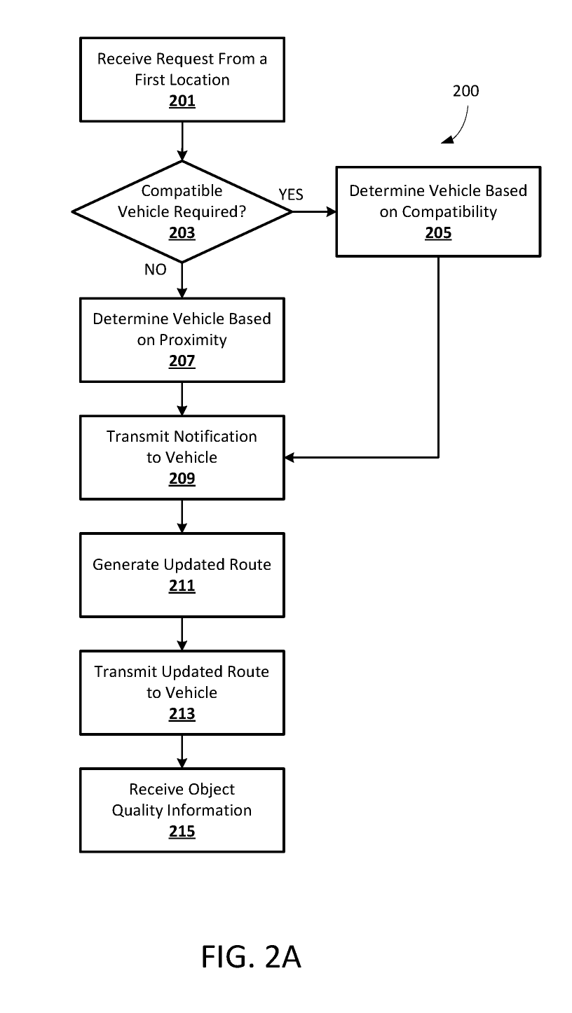

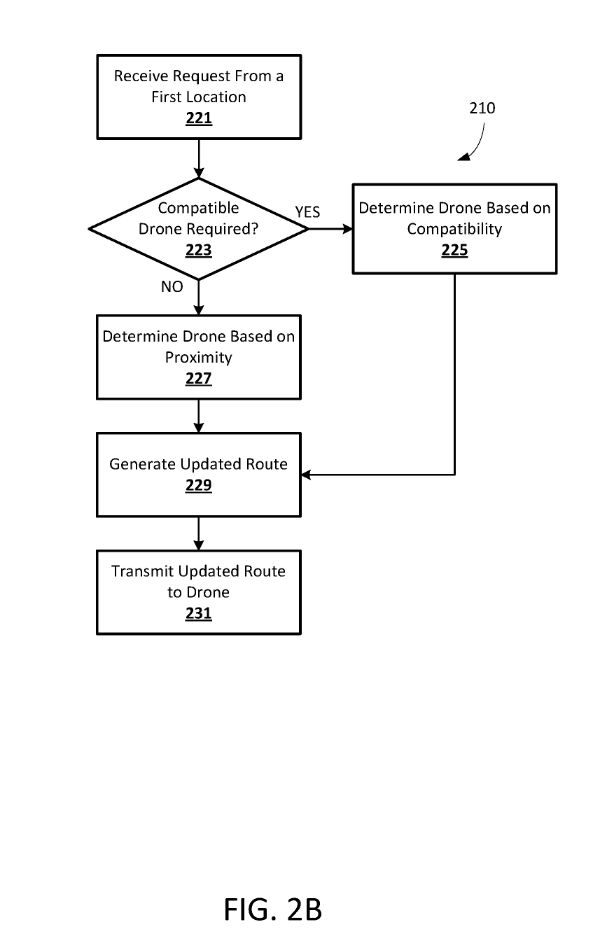

FIG. 2A is a flowchart illustrating another exemplary method 200 for determining relocation destinations for distributed objects, dynamically specifying one or more parameters for the objects at the relocation destinations, and/or dynamically generating rerouting instructions associated with the objects and the relocations destinations, according to an exemplary embodiment. It will be appreciated that the method is programmatically performed, at least in part, by one or more computer-executable processes executing on, or in communication with one or more servers described further below. In step 201, a first server, in communication with a mobile electronic device and one or more databases, receives a request to retrieve an object from a first location via a mobile application or an online account. In exemplary embodiments, an individual can request that an object that was previously delivered to the first location be retrieved and/or relocated. In some embodiments, the individual can request retrieval of the object and track the progress of the retrieval and relocation using the mobile application or online account.

In step 203, the first server can determine whether the object requires a particular type of compatible vehicle. For example, the object may need to be retrieved by a refrigerated truck. In another example, the object can have dimensions requiring the a vehicle suitable for the dimensions of the object (alone or in combination with other objects that may already be in the vehicle).

If it is determined in step 203 that the object requires a particular type of compatible vehicle, the method continues in step 205 with determining a vehicle responsible for retrieving the object from a pool of possible vehicles based on compatibility with the object. If it is determined in step 203 that the object does not require a particular type of compatible vehicle, the method continues in step 207 with determining a vehicle responsible for retrieving the object based on the geographic proximity of vehicles to the first location or regularly scheduled route to the first location, which can be retrieved from the database(s). As one example, the vehicles can have location modules for determining the current geographic locations of the vehicles. Each vehicle can execute an application, as a background process, which can periodically transmit the current geographical location of the vehicle and/or can transmit the current geographic location of the vehicle in response to receipt of a location request message from the first server. As another example, individuals in the vehicles can have mobile electronic devices with location modules for determining the current geographic locations of the individuals. Each mobile electronic device can be associated with a vehicle and can execute an application, as a background process, which can periodically transmit the current geographical location of the mobile device and/or can transmit the current geographic location of the mobile device in response to receipt of a location request message from the first server. The mobile electronic device associated with the vehicle, can be a smartphone, tablet, GPS enabled device, etc.

Once the vehicle responsible for retrieving the object has been determined in either step 205 or step 207, the method continues in step 209 with transmitting a notification to the vehicle or associated mobile electronic device prompting the vehicle or mobile electronic device to retrieve the object from the first location. The notification can include, for example, a visual and/or audio notification that can cause the background process executing on the vehicle or the mobile electronic device to activate a foreground process that is configured to generate an alert the operator of the vehicle or mobile electronic that the object needs to be retrieved. The responsible vehicle or the associated mobile electronic device can include a routing application that receives a set of statically specified and ordered stops or pickup locations and an associated route from the first server, for example, before the vehicle begins its route. The routing application can guide the user of the vehicle or the associate mobile electronic device along the route to each of the stops or pickup locations based on the order of the stops or pickup locations specified by the first server.

In step 211, in response to determining the responsible vehicle, the first server dynamically generates an updated vehicle route including the first location, using a vehicle reroute module. As described herein, in exemplary embodiments, the vehicle responsible for retrieving the object can already be assigned a delivery or retrieval route. In such cases, the vehicle reroute module can generate a new or modified route that includes the first location. For example, the first server can insert the first location into the ordered sequence of stops or pickup locations. In exemplary embodiments, the first location can be inserted into the updated route by the first server to minimize the distance traveled or time traveled by the vehicle. In other embodiments, the updated route can be designed based on the priority of the various stops along the route, an amount of space needed within the vehicle to retrieve the object, or other delivery and/or retrieval factors.

In step 213, the updated vehicle route is transmitted to the mobile electronic device associated with the vehicle. In exemplary embodiments, transmitting the updated vehicle route to the mobile electronic device can automatically initiate navigational instructions to guide the vehicle along the updated route.

In step 215, the first server receives information related to the object from the mobile electronic device associated with the vehicle responsible for retrieving the object. In exemplary embodiments, once the vehicle arrives at the first location, the operator of the vehicle can use the mobile electronic device to input the information related to the object (e.g., a current quality of the object) and this information can be transmitted to the first server by the mobile electronic device . Alternatively, or in addition, embodiments, the mobile electronic device can scan a machine-readable code associated with the object in order to determine the current quality of the product or another product attribute in order to transmit this information to the first server.

In exemplary embodiments, once the vehicle responsible for retrieving the object has been rerouted and retrieves the object, the vehicle can proceed to deliver the object to the destination location. In some embodiments, the destination location can be determined as described above in reference to FIG. 1. In alternative embodiments, the destination location can be determined before generating an updated vehicle route or before determining a vehicle responsible for retrieving the object.

FIG. 2B is a flowchart illustrating another exemplary method 210 for determining relocation destinations for distributed objects, dynamically specifying one or more parameters for the objects at the relocation destinations, and/or dynamically generating rerouting instructions associated with the objects and the relocations destinations, according to an exemplary embodiment. It will be appreciated that the method is programmatically performed, at least in part, by one or more computer-executable processes executing on, or in communication with one or more servers described further below. In step 221, a first server, in communication with a mobile electronic device and one or more databases, receives a request to retrieve an object from a first location via a mobile application or an online account. In exemplary embodiments, an individual can request that an object that was previously delivered to the first location be retrieved and/or relocated, and the object can be retrieved by a drone or autonomous electronic device. In some embodiments, the individual can request retrieval of the object and track the progress of the retrieval and relocation using the mobile application or online account.

In step 223, the first server can determine whether the object requires a particular type of compatible drone for retrieval. For example, the object may need to be retrieved by a drone of a particular size.

If it is determined in step 223 that the object requires a particular type of compatible drone, the method continues in step 225 with determining a drone responsible for retrieving the object from a pool of possible drones based on compatibility with the object. If it is determined in step 223 that the object does not require a particular type of compatible drone, the method continues in step 227 with determining a drone responsible for retrieving the object based on the geographic proximity of drones to the first location or regularly scheduled routes to the first location, which can be retrieved from the database(s). As one example, the drones can have location modules for determining the current geographic locations of the drones. Each drone can execute an application, as a background process, which can periodically transmit the current geographical location of the drone and/or can transmit the current geographic location of the drone in response to receipt of a location request message from the first server.

Once the drone responsible for retrieving the object has been determined in either step 225 or step 227, the method continues in step 229 with dynamically generating an updated drone route including the first location, using a drone reroute module. As described herein, in exemplary embodiments, the drone responsible for retrieving the object can already be assigned a delivery or retrieval route. In such cases, the drone reroute module can generate a new or modified route that includes the first location. For example, the first server can insert the first location into an ordered sequence of stops or pickup locations. In exemplary embodiments, the first location can be inserted into the updated route by the first server to minimize the distance traveled or time traveled by the vehicle. In other embodiments, the updated route can be designed based on the priority of the various stops along the route, the drone's capacity to retrieve the object, or other delivery and/or retrieval factors.

In step 231, the updated route is transmitted to the drone. In exemplary embodiments, transmitting the updated route to the drone can automatically initiate navigational instructions to guide the drone along the updated route to retrieve the object at the first location. In exemplary embodiments, once the drone responsible for retrieving the object has been rerouted and retrieves the object, the drone can proceed to deliver the object to the destination location. In some embodiments, the destination location can be determined as described above in reference to FIG. 1. In alternative embodiments, the destination location can be determined before generating an updated drone route or before determining a drone responsible for retrieving the object.

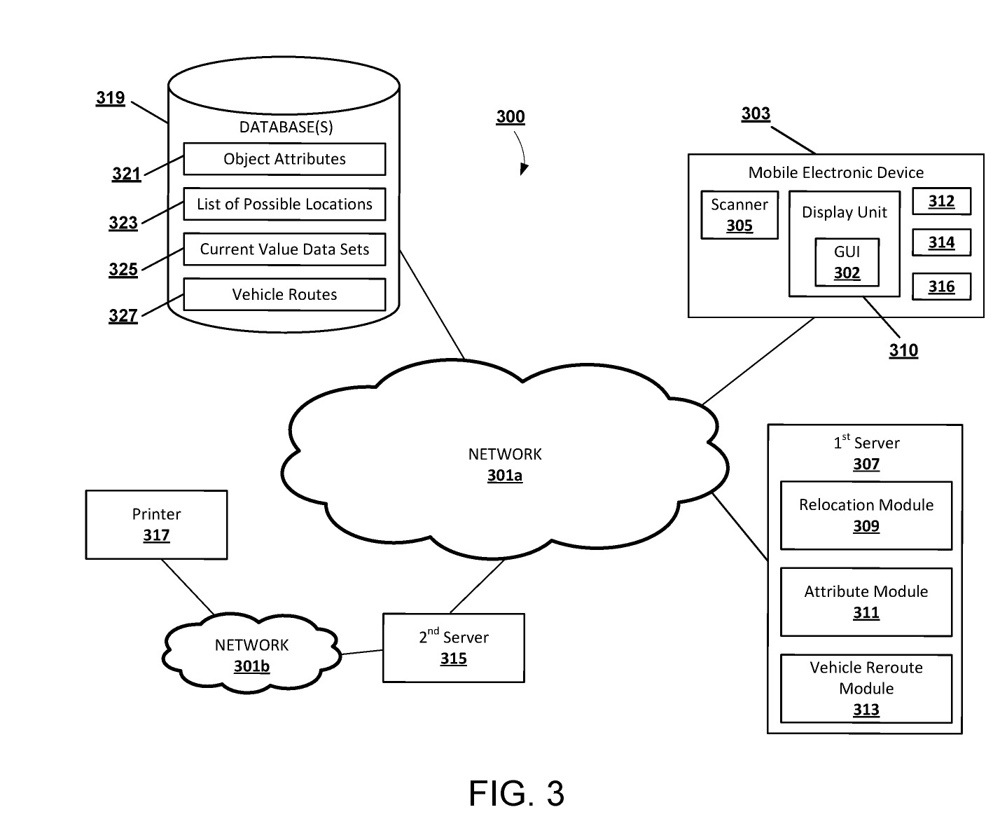

FIG. 3 illustrates a network diagram depicting a system 300 suitable for a distributed implementation of an exemplary embodiment. The system 300 can include a first network 301a, a second network 301b, a mobile electronic device 303 associated with a vehicle, a first server 307, a second server 315, a printer 317, and a database 319. As will be appreciated, various distributed or centralized configurations may be implemented without departing from the scope of the present invention. In exemplary embodiments, the first server 307 can include a relocation module 309, an attribute module 311, and a vehicle reroute module 313, which can implement one or more of the processes described herein with reference to FIGS. 1-2, or portions thereof. It will be appreciated that the module functionality may be implemented as a greater number of modules than illustrated and that the same server or computing system could also host multiple modules. The database 319 can store the object attributes 321, a list of possible relocation destinations 323, the current value data sets 325 described in reference to FIG. 1, and the vehicle routes 327, as discussed herein.

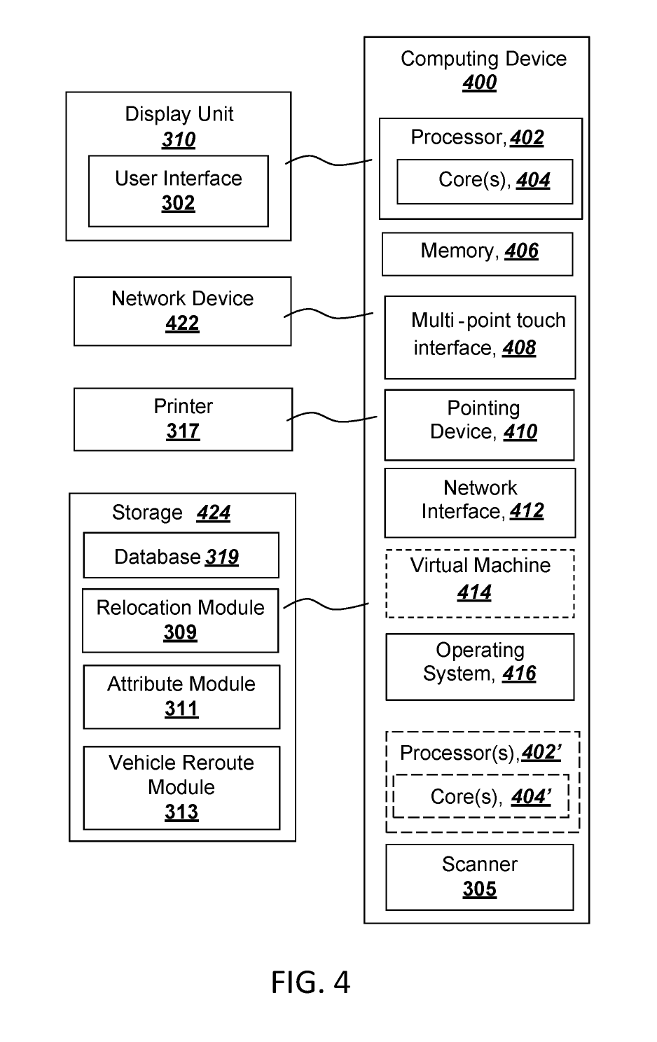

In exemplary embodiments, the mobile electronic device 303 may include a display unit 310, which can display a GUI 302 to a user of the mobile electronic device 303. The mobile electronic device 303 can also include a memory 312, processor 314, and a wireless interface 316, as well as a scanner 305 configured to scan a machine-readable code associated with an object. In some embodiments, the mobile electronic device 303 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, and the like. The mobile electronic device 303 may include some or all components described in relation to computing device 400 shown in FIG. 4.

The mobile electronic device 303 may connect to a network 301a via a wired or wireless connection. The mobile electronic device 303 may include one or more applications such as, but not limited to, a mobile application for scheduling deliveries, a web browser, a sales transaction application, an object reader application, a geo-location application, and the like.

In exemplary embodiments, the mobile electronic device 303, first server 307, second server 315, and database 319 may be in communication with each other via the communication network 301a. The printer 317 can be in communication with the second server 315 via different communication network 301b. The communication network 301a may include, but is not limited to, the Internet, an intranet, a LAN (Local Area Network), a WAN (Wide Area Network), a MAN (Metropolitan Area Network), a wireless network, an optical network, and the like. In one embodiment, the mobile electronic device 303, first server 307, second server 315, and database 319 can transmit instructions to each other over the communication network 301a. In exemplary embodiments, the object attributes 321, a list of possible relocation destinations 323, the current value data sets 325, and the vehicle routes 327 can be stored at the database 319 and received at the mobile electronic device 303, the first server 3070, or the second server 315 in response to a service performed by a database retrieval application.

FIG. 4 is a block diagram of an exemplary computing device 400 that can be used in the performance of the methods described herein. The computing device 400 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 406 included in the computing device 400 can store computer-readable and computer-executable instructions or software for implementing exemplary embodiments and programmed to perform processes described above in reference to FIGS. 1-2. The computing device 400 also includes processor 402 and associated core 404, and optionally, one or more additional processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ can each be a single core processor or multiple core (404 and 404′) processor.

Virtualization can be employed in the computing device 400 so that infrastructure and resources in the computing device can be shared dynamically. A virtual machine 414 can be provided to handle a process running on multiple processors so that the process appears to be using only one computing resource rather than multiple computing resources. Multiple virtual machines can also be used with one processor.

Memory 406 can be non-transitory computer-readable media including a computer system memory or random access memory, such as DRAM, SRAM, EDO RAM, and the like. Memory 406 can include other types of memory as well, or combinations thereof.

A user can interact with the computing device 400 through a display unit 310, such as a touch screen display or computer monitor, which can display one or more user interfaces 302 that can be provided in accordance with exemplary embodiments. The computing device 400 can also include other I/O devices for receiving input from a user, for example, a keyboard or any suitable multi-point touch interface 408, a pointing device 410 (e.g., a pen, stylus, mouse, or trackpad). The multi-point touch interface 408 and the pointing device 410 can be coupled to the display unit 310. The computing device 400 can include other suitable conventional I/O peripherals. The computing device 400 can also include a scanner 305, such as an optical scanner, that can scan and read a machine-readable code, as discussed above. The scanner 305 can be for example a barcode reader, RFID reader, or image capturing device that can scan and read the machine-readable code. The computing device 400 can also be in communication with a printer 317.

The computing device 400 can also include one or more storage devices 424, such as a hard-drive, CD-ROM, or other non-transitory computer readable media, for storing data and computer-readable instructions and/or software, such as a relocation module 309, an attribute module 311, and vehicle reroute module 313 that can implement exemplary embodiments of the methods and systems as taught herein, or portions thereof. Exemplary storage device 424 can also store one or more databases 319 for storing any suitable information required to implement exemplary embodiments. The databases 319 can be updated by a user or automatically at any suitable time to add, delete, or update one or more items in the databases. Exemplary storage device 424 can store one or more databases 319 for storing the object attributes 321, list of possible locations 323, current value data sets 325, vehicle routes 327, and any other data/information used to implement exemplary embodiments of the systems and methods described herein.

The computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 can include a built-in network adapter, network interface card, PCMCIA network card, card bus network adapter, wireless network adapter, USB network adapter, modem or any other device suitable for interfacing the computing device 400 to any type of network capable of communication and performing the operations described herein. Moreover, the computing device 400 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 400 can run an operating system 416, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or other operating systems capable of running on the computing device and performing the operations described herein. In exemplary embodiments, the operating system 416 can be run in native mode or emulated mode. In an exemplary embodiment, the operating system 416 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for determining relocation destinations for distributed objects, the system comprising:
a mobile electronic device configured to scan a machine-readable code associated with an object to be relocated from a first location;
one or more databases configured to store information related to the object, the information including an attribute of the object and an amount of time the object has been at the first location; and
a computing system including a first server in communication with the mobile electronic device and the one or more databases and a second server in communication with the first server, the one or more databases, and a printer,
the first server configured to:
execute a relocation module to determine a destination location from a plurality of possible locations for the object, the first server being at a different location than the destination location; and
execute an attribute module to compute a set of data representative of a current value of the object, wherein the set of data is computed, at least in part, based on an attribute of the object, the amount of time the object has been at the first location, a current quality of the object, or the destination location,
the second server and the printer being disposed at the destination location, the second server being configured to:
receive the set of data; and
autonomously control the printer at the destination location to print a visual representation of the set of data on a label to be affixed to the object.

2. The system of claim 1, wherein the first server is further configured to receive a request to retrieve the object from the first location via a mobile application or online account.

3. The system of claim 2, wherein the first server is further configured to:
determine a vehicle responsible for retrieving the object;
transmit a notification to the vehicle, prompting the vehicle to retrieve the object from the first location; and
receive information related to the current quality of the object from the mobile electronic device, wherein the mobile electronic device is associated with the vehicle responsible for retrieving the object.

4. The system of claim 3, wherein the first server is further configured to:
generate an updated vehicle route including the first location; and
transmit the updated vehicle route to the mobile electronic device associated with the vehicle.

5. The system of claim 3, wherein the vehicle responsible for retrieving the object is determined based on a proximity of the vehicle's scheduled route to the first location.

6. The system of claim 3, wherein determining the vehicle responsible for retrieving the object includes determining that the responsible vehicle is compatible for proper transportation of the object.

7. The system of claim 1, wherein the destination location is a source location from which the object originated or a distribution center.

8. A method for determining relocation destinations for distributed objects, the method comprising:
scanning a machine-readable code associated with an object to be relocated from a first location using a mobile electronic device;
storing information related to the object, including an attribute of the object and an amount of time the object has been at the first location, in one or more databases;
determining, using a first server, a destination location from a plurality of possible locations for the object, the first server being at a different location than the destination location;
computing a set of data representative of a current value of the object, using the first server, wherein the set of data is computed, at least in part, based on the attribute of the object, the amount of time the object has been at the first location, a current quality of the object, or the destination location;
receiving the set of data at a second server disposed at the destination location; and
autonomously controlling a printer at the destination location to print a visual representation of the set of data on a label to be affixed to the object.

9. The method of claim 8, further comprising receiving a request, at the first server, to retrieve the object from the first location via a mobile application or online account.

10. The method of claim 9, further comprising:
determining a vehicle responsible for retrieving the object;
transmitting a notification to the vehicle prompting the vehicle to retrieve the object from the first location; and
receiving information related to the current quality of the object from the mobile electronic device, wherein the mobile electronic device is associated with the vehicle responsible for retrieving the object.

11. The method of claim 10, further comprising:
generating an updated vehicle route including the first location; and
transmitting the updated vehicle route to the mobile electronic device associated with the vehicle.

12. The method of claim 10, wherein determining the vehicle responsible for retrieving the object is based on a proximity of the vehicle's scheduled route to the first location.

13. The method of claim 10, wherein determining the vehicle responsible for retrieving the object includes determining that the responsible vehicle is compatible for proper transportation of the object.

14. The method of claim 8, wherein the destination location is a source location from which the object originated or a distribution center.

15. A non-transitory machine readable medium storing instructions for determining relocation destinations for distributed objects executable by a processing device, wherein execution of the instructions causes the processing device to:
scan a machine-readable code associated with an object to be relocated from a first location using a mobile electronic device;
store information related to the object, including an attribute of the object and an amount of time the object has been at the first location, in one or more databases;
determine, using a first server, a destination location from a plurality of possible locations for the object, the first server being at a different location than the destination location;
compute a set of data representative of a current value of the object, using the first server, wherein the set of data is computed, at least in part, based on the attribute of the object, the amount of time the object has been at the first location, a current quality of the object, or the destination location;
receive the set of data at a second server disposed at the destination location; and
autonomously control a printer at the destination location to print a visual representation of the set of data on a label to be affixed to the object.

16. The non-transitory machine readable medium of claim 15, wherein execution of the instructions further causes the processing device to receive a request to retrieve the object from the first location via a mobile application or online account.

17. The non-transitory machine readable medium of claim 16, wherein execution of the instructions further causes the processing device to:
determine a vehicle responsible for retrieving the object;
transmit a notification to the vehicle prompting the vehicle to retrieve the object from the first location; and
receive information related to the current quality of the object from the mobile electronic device, wherein the mobile electronic device is associated with the vehicle responsible for retrieving the object.

18. The non-transitory machine readable medium of claim 17, wherein execution of the instructions further causes the processing device to:
generate an updated vehicle route including the first location; and
transmit the updated vehicle route to the mobile electronic device associated with the vehicle.

19. The non-transitory machine readable medium of claim 17, wherein determining the vehicle responsible for retrieving the object is based on a proximity of the vehicle's scheduled route to the first location.

20. The non-transitory machine readable medium of claim 15, wherein determining the vehicle responsible for retrieving the object includes determining that the vehicle is compatible for proper transportation of the object.
